(19) United States
(12) Patent Application Publication
(10) Pub. No.: US 2018/0200991 A1
(43) Pub. Date: Jul. 19, 2018

(54) MULTILAYER PLAIN BEARING ELEMENT

(71) Applicant: Miba Gleitlager Austria GmbH, Laakirchen (AT)

(72) Inventor: Falko LANGBEIN, Gmunden (AT)

(73) Assignee: Miba Gleitlager Austria GmbH, Laakirchen (AT)

(21) Appl. No.: 15/744,172

(22) PCT Filed: Aug. 13, 2015
(86) PCT No.: PCT/AT2015/050201

§ 371 Date: Jan. 12, 2018

(51) Int. Cl. B32B 15/01; B22D 19/16; B22D 11/00; B22D 11/06; F16C 33/12

(52) U.S. Cl. CPC B32B 15/012; B32B 15/016; B22D 19/16; C22C 21/003; B22D 11/008; B22D 11/0605; F16C 33/127; B22D 11/003

(57) ABSTRACT

The invention relates to a multilayer plain bearing element (14) composed of a composite material comprising a supporting layer (2), a binding layer (3) connected to the supporting layer (2), and a bearing metal layer (4) connected to the binding layer (3), wherein the binding layer (3) is composed of aluminum or a first, soft-phase-free aluminum-based alloy and the bearing metal layer (4) is composed of a second aluminum-based alloy containing at least one soft phase, and the binding layer (3) and the bearing metal layer (4) are connected to each other by means of a fusion-metallurgy connection in such a way that a binding zone arranged between the bonding layer (3) and the bearing metal layer (4) is formed, wherein grains (9,10) are formed in the binding zone and a continuous grain boundary course between the binding layer (3) and the bearing metal layer (4) is formed in the binding zone.

The invention relates to a multilayer plain bearing element made from a composite material comprising a supporting layer, a bonding layer joined to the supporting layer and a bearing metal layer joined to the bonding layer, the bonding layer being made from aluminum or a first, soft-phase-free aluminum-based alloy and the bearing metal layer being made from a second aluminum-based alloy containing at least one soft phase, and the bonding layer and the bearing metal layer are joined to one another by means of a fusion-metallurgy join forming a bonding zone between the bonding layer and the bearing metal layer, grains being formed in the bonding zone.

The invention further relates to a method for producing a multilayer plain bearing element comprising the steps: producing a two-layer primary material from a first aluminum-based alloy forming a first layer of the primary material and a second aluminum-based alloy forming a second layer of the primary material by composite casting, joining the two-layer primary material to a substrate forming a supporting layer of the multilayer plain bearing by roll bonding and finishing the roll-bonded composite material to obtain the multilayer plain bearing element.

These days, primary materials for steel-aluminum composite plain bearings are mainly produced by roll bonding processes. To this end, bearing materials with a base of tin-free aluminum alloys are roll bonded directly onto steel. Classic aluminum alloys containing tin, such as AlSn6Cu or AlSn40Cu for example, additionally require a bonding film in order to bond with the steel, e.g. of pure aluminum disposed between the steel and the bearing metal. The preliminary join between the bearing metal and binding film is produced exclusively by roll bonding. However, the disadvantage of roll-bonded composites is that the joining process enables only adhesive bonds to be obtained.

From the prior art, e.g. EP 0 966 333 A1 or DE 103 33 589 B4, methods are also known whereby the bearing metal alloy is applied to the steel by a casting process. However, such methods of working with primary materials cannot be used with the material combination of steel-aluminum. The reason for this is that iron is virtually insoluble in aluminum (at 655° C. 0.052% by weight Fe, at 600° C. 0.025% by weight Fe, at 500° C. 0.006% by weight Fe). At high temperatures (e.g. above 400° C.), a thermodynamically induced diffusion reaction occurs between iron and aluminum, followed by the formation of complex intermetallic phases. These lead to a significant reduction in the adhesive strength of the composites which is therefore undesirable.

EP 0 947 260 A1 discloses the use of monotectic alloys for producing plain bearings by casting a melt that has been heated to a temperature above the demixing temperature at a high casting and cooling rate in order to directly clad steel substrates without applying any intermediate layers. Non-monotectic alloys (e.g. standard aluminum-tin bearing alloys) are ruled out and cannot be used for direct cladding, in particular because the element tin does not form a bond with the steel and/or sufficient adhesive strength during roll bonding.

DE 20 14 497 A discloses a method for producing a plain bearing whereby a steel strip is coated with an Al—Si alloy in a first step by the Aludip method and an aluminum alloy containing Sn and Pb is then applied to the latter in another step by casting.

GB 749,529 A describes a method for producing a plain bearing whereby a two-layer primary material is produced first of all by casting an aluminum-tin alloy on a plate of aluminum, this primary material then being rolled so that it is bonded to a steel substrate via the tin-free side after rolling.

The fact that the performance levels of new generations of engines are expected to increase by up to 20% in future means that loads on bearings will increase.

Accordingly, the objective of the invention is to propose a multilayer plain bearing element having an aluminum-based alloy as the bearing alloy layer which is better able to withstand higher bearing loads.

This objective of the invention is achieved by means of the multilayer plain bearing element outlined above due to the fact that a continuous grain boundary gradient is formed in the bonding zone between the bonding layer and bearing metal layer.

The objective of the invention is also achieved by means of the method outlined above whereby the composite casting process for producing the primary material is operated in a device having at least three different zones and, in a first zone a first strand of aluminum or one of the aluminum-based alloys is produced from a first aluminum (alloy) melt, in a second zone the strand of aluminum or first aluminum (alloy) melt is cooled until it has a solidified first surface and in a third zone a second strand of aluminum or the other aluminum-based alloy based on a second aluminum (alloy) melt is cast on to the solidified first surface, with the proviso that if using aluminum, the other strand is produced respectively from the second aluminum alloy.

The bonding layer disposed between the supporting layer and bearing metal layer improves the bond strength between the bonding layer and bearing metal layer, and the adhesive strength is improved due to the fact that no microscopically visible boundary layer is created between these two layers as a result of the production process and instead, the transition in the region of the grain boundaries flows, in other words there is a continuous grain boundary gradient from the bonding layer to the bearing metal layer. Any interruptions in the grain boundary region between these two layers are therefore avoided. The improved strength of the layer bonding thus obtained also has advantages in terms of crack propagation. It has been found that in clad bonds, when a crack originating in the bearing metal layer hits the binding film, it does not or does not always penetrate the bonding layer material and instead moves along the boundary surface of the bonding layer/bearing metal layer which can lead to delamination. In the case of the layer bonding obtained by the invention, the crack is not propagated along the bonding zone and instead, the crack continues on into the bonding layer due to the continuous grain boundary gradient and it may be that cracking is halted depending on the strength of the bonding layer. Delamination can therefore be effectively prevented. The plain bearing itself still has a certain ability to function if damaged by cracking because the bearing pin is prevented from coming into contact with materials that are poorly suited to tribological applications. If using bonding layers of higher strength (higher strength than that of the bearing material), the overall strength of the supporting composite can also be adjusted and varied in a specifically intended way. However, it is also possible to combine a higher strength bearing material with a somewhat softer and tougher bonding layer, in which case damping characteristics can be improved. This means that properties such as adaptability and damping characteristics can be adapted to the respective requirements. In the case of applications where a high degree of adaptability is needed, a layer structure with a thicker bearing metal layer and slightly thinner bonding layer is used. If strength is a higher priority, the reverse design is possible. In addition, the bi-metal effect (which affects the expansion behavior and endurance characteristics of bearing shells) can be influenced by means of the bonding layer (strength, layer thicknesses, thickness ratios).

Based on one embodiment of the multilayer plain bearing element, the first aluminum-based alloy of the bonding layer and/or the second aluminum-based alloy of the bearing metal layer contains or contain at least one (other) alloy element and the alloy element has a concentration gradient in the bonding zone formed between the bonding layer and bearing metal layer. This alloy element may also be the soft phase element, in which case the soft phase element may be provided at least partially with a concentration gradient in the radial direction of the multilayer plain bearing element. This (other) alloy element imparts specific properties to the bearing metal in a known manner, such as improved lubricating capacity, greater hardness due to elements forming intermetallic phases for example, e.g. aluminides, etc. By creating the hardness gradient, the transition of the properties of the bonding layer and bearing metal layer is “softer”, thereby enabling the bonding strength between the bonding layer and bearing metal layer to be further improved.

Based on another embodiment of the multilayer plain bearing element, the grain size of the grains in the bonding zone formed between the bonding layer and bearing metal layer has an average diameter of at most 100 μm. The bond strength can therefore be improved due to the larger specific surface between the bonding layer and bearing metal layer.

With regard to any crack propagation which might occur due to the avoidance of notching effects, it is of advantage if a proportion of at least 25% of the grains relative to the totality of grains in the bonding zone have an approximately globular habit, at least in the bonding zone formed between the bonding layer and bearing metal layer.

Based on another embodiment of the multilayer plain bearing element, the first aluminum-based alloy of the bonding layer with the exception of the at least one soft phase element may have the same qualitative composition as the second aluminum-based alloy of the bearing alloy layer. Accordingly, with the exception of the soft phase element, the same elements are present in the two layers. This being the case, the aluminum-based alloys of the bonding layer and bearing alloy layer exhibit similar solidification behavior, thereby enabling the rolling behavior of the primary material to be improved. In addition, however, this also enables the recyclability of such composite materials to be improved because the fact that the two aluminum-based alloys are of a similar nature means that cast compounds can be more easily returned to the circuit for producing the primary material.

Based on one embodiment of the method, the first strand may be cooled in a cooling line having top cooling circuits assigned to the first surface of the first strand and bottom cooling circuits assigned to a second surface of the first strand, and the number of top cooling circuits is smaller than the number of bottom cooling circuits. This makes it easier to influence thermal conditions in the strand, thereby improving formation of the continuous grain boundary gradient in the bonding zone after subsequently casting on the second strand.

It is preferable if the first strand is cooled in the region of the first surface at a cooling rate averaged across the entire cooling line selected from a range of 1° C./s to 15° C./s. It is also preferable if the first strand is cooled in the region of the first surface to a temperature that is not less than 400° C. in the first zone. Due to at least one of these features, in particular due to both of them together, the layer thickness of the bonding zone can be influenced. This also has a positive effect on the adhesive strength by which the bonding layer is bonded to the bearing alloy layer.

The first strand is preferably cooled in the region of lateral sides before casting the second strand. As a result of the lateral cooling, an even solidification front is created and the “sump depth” is not dependent on the casting width. As a result, during the subsequent casting process, virtually the same thermal conditions prevail across the casting width, which significantly improves the bond strength of the primary material.

Having been cast onto the first surface of the first strand, the second strand can be cooled by another cooling circuit, the solidification front of the second strand being formed upstream of this other cooling circuit. Again with this embodiment of the method, the bond strength can be further improved by opting for a relatively long dwell time of the liquid melt of the second strand on the first strand. This additionally results in a one-sided solidification directed from the first strand in the direction towards the second strand, which also has a positive effect on the adhesive strength by which the second strand is bonded to the first strand. The fact that solidification is directed in this manner means that impurities and faults, such as pores or blowholes, “migrate” in the direction of the surface, in other words are removed from the bonding zone. Their presence at the surface is not problematic because the surface is usually mechanically finished and/or has material removed from it so that any impurities, etc., are removed from the multilayer plain bearing element. This specifically directed solidification can be achieved due to the fact that at least a major part of the energy applied with the second strand is dispersed via the first strand so that the second strand solidifies before being actively cooled by means of a cooling device.

In terms of “migrating” impurities and/or faults in the casting structure, it is of advantage if the first aluminum-based alloy is produced with a substantially globular structure and the second aluminum-based alloy is produced with a substantially dendritic structure because this better prevents “back-migration” in the opposite direction.

Based on another embodiment of the method, the aluminum alloys used to produce the first and second strand may have melting points which differ by at most 15% relative to the melting point of the aluminum-based alloy having the higher melting point or, if using aluminum to produce the first or second strand, the aluminum-based alloy used for the other strand has a melting point which is at most 15% higher than the melting point of aluminum. Accordingly, by casting the respective material, the first material can be heated during casting to a temperature that is conducive to forming the bond due to diffusion processes taking place between the two layers as they are being formed.

With regard to the speed of the process and the thermal conditions in the casting area, it has proved to be of advantage if a layer thickness ratio (in the cast state) D is between 2:1 and 1:10, the layer thickness ratio being the ratio of the layer thickness of the substrate to the layer thickness of the cast layer.

To provide a clearer understanding, the invention will be described in more detail below with reference to the appended drawings.

These are simplified, schematic diagrams respectively illustrating the following:

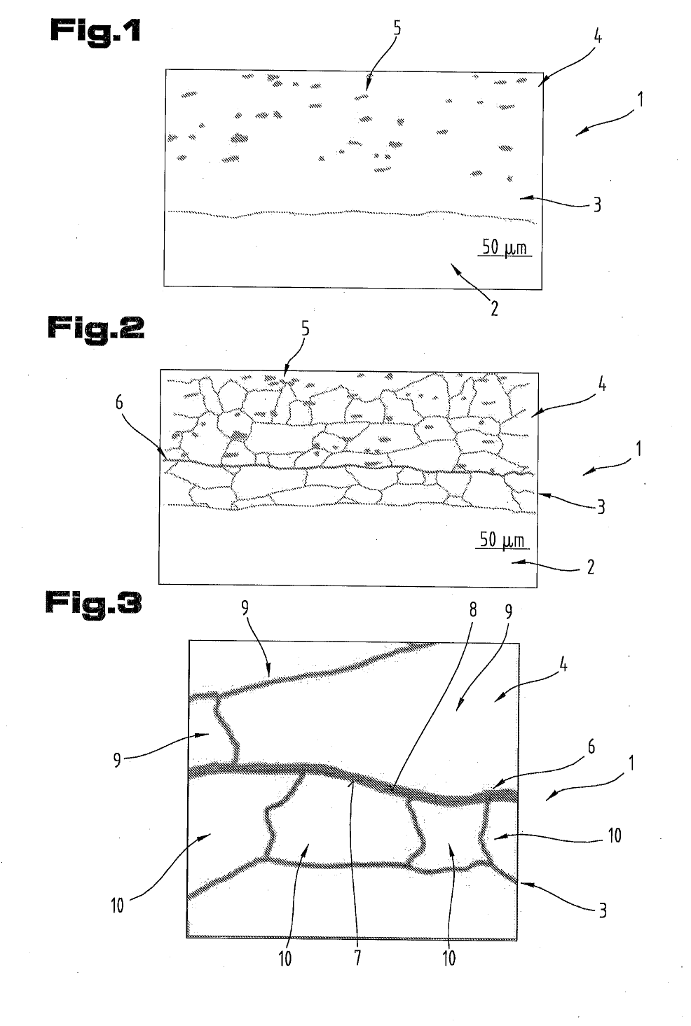

FIG. 1 the structure of the macrostructure of a so-called two-material plain bearing known from the prior art without etching;

FIG. 2 the structure of the microstructure of the two-material plain bearing known from the prior art with grain boundary etching (microstructure of the supporting body not illustrated);

FIG. 3 a detail from the microstructure of the two-material bearing illustrated in FIG. 2 in the region of the interface between the bonding layer metal and bearing metal with grain boundary etching for aluminum;

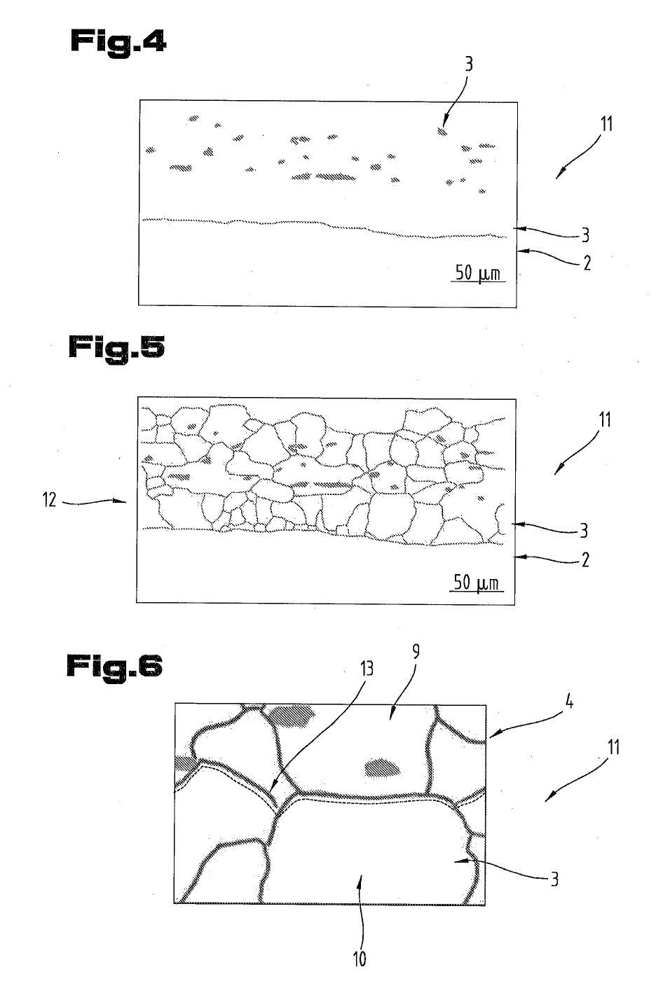

FIG. 4 the structure of the macrostructure of a primary material proposed by the invention for a two-material plain bearing without etching;

FIG. 5 the structure of the microstructure of a primary material proposed by the invention for a two-material plain bearing with etching of the grain boundaries (supporting layer microstructure not illustrated);

FIG. 6 a detail of the microstructure of the join between the bonding layer and bearing metal layer of the primary material illustrated in FIG. 2 with etching of the grain boundaries for aluminum;

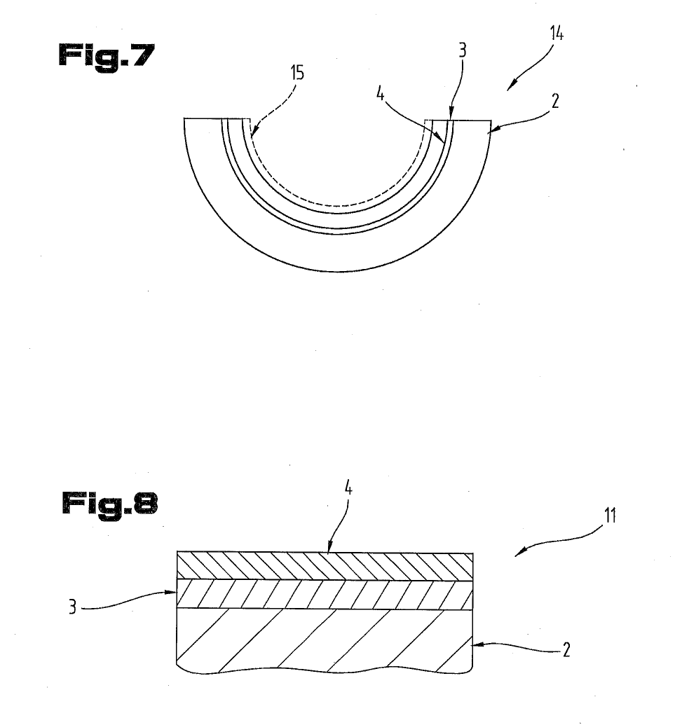

FIG. 7 a side view of a multilayer plain bearing element;

FIG. 8 a section based on one embodiment of a layered composite;

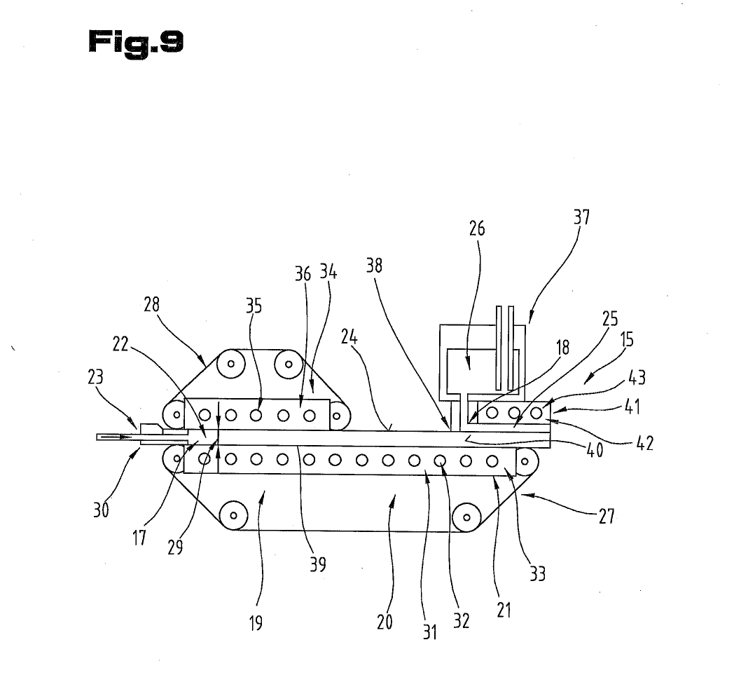

FIG. 9 a side view in section of a device for producing the primary material for the multilayer plain bearing element;

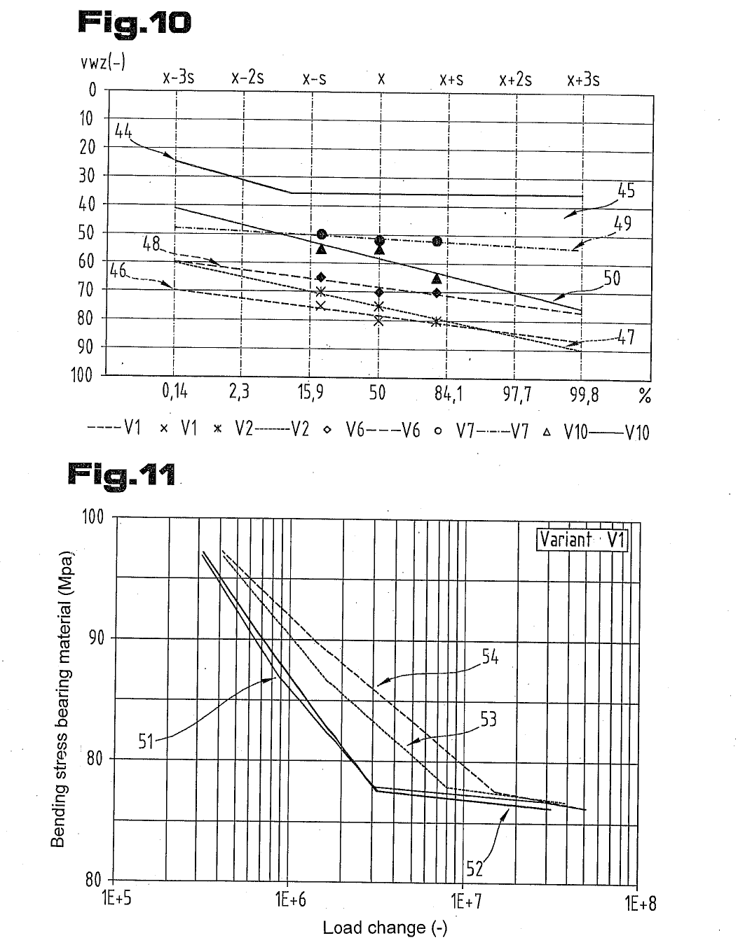

FIG. 10 the qualitative bonding strength determined by means of a torsion test on composites obtained by means of the invention compared with composites produced by the conventional method;

FIG. 11 the flexural fatigue strength of a composite obtained by means of the invention compared with a composite produced by the conventional method;

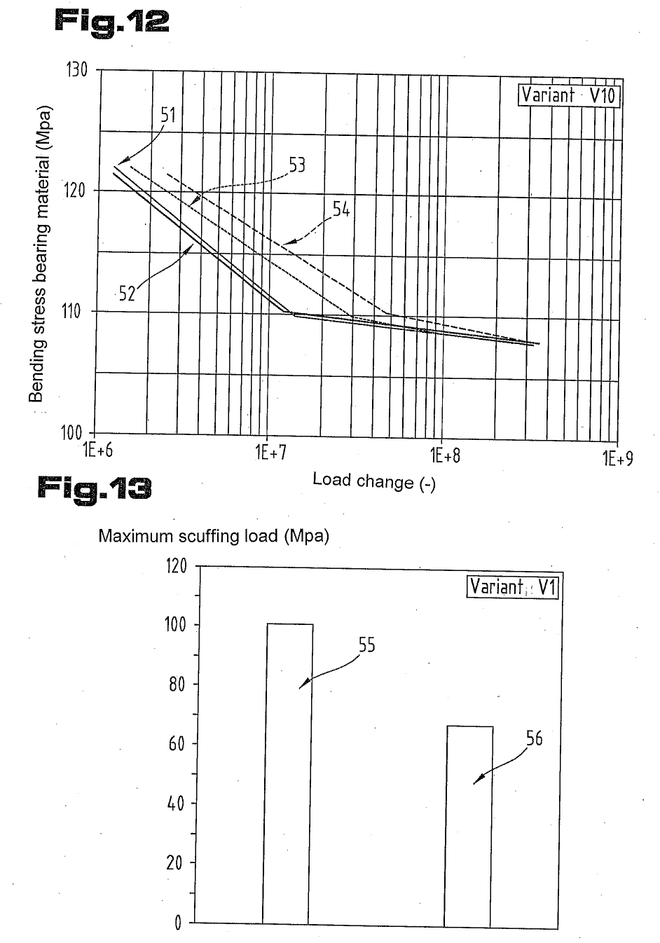

FIG. 12 the flexural fatigue strength of a composite obtained by means of the invention compared with a composite produced by the conventional method;

FIG. 13 the maximum scuffing load of a composite obtained by means of the invention compared with a composite produced by the conventional method.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

To provide a clearer understanding of the invention, a brief explanation of the prior art relating to roll bonding will be given.

FIGS. 1 to 3 schematically illustrate a section (macroscopic and microscopic) from the structure of a steel-aluminum plain bearing 1 based on the prior art.

This plain bearing 1 has a supporting layer 2 made from steel. Applied on top of it is a bonding layer 3 made from pure aluminum. Disposed on top of the bonding layer 3 is a bearing metal layer 4 made from an aluminum alloy constituting the antifriction layer of the plain bearing 1. The aluminum alloy has a tin content of up to 50% by weight. The tin constituent is a so-called soft phase 5 and is used as a lubricant in situations where oil lubrication is deficient to prevent mixed friction and in the worst case scenario total wearing of the plain bearing 1. Tin is present as a heterogeneous constituent in the aluminum alloy.

The bonding layer 3 serves exclusively to create a bond between the supporting layer 2 and the bearing metal layer 4. Due to the proportion of soft phases 5 in the bearing metal layer 4, it is not possible to create a direct bond with the supporting layer 2. The macroscopic structure (FIG. 1) of this bearing structure is therefore characterized by a combination of three different materials, namely steel, pure aluminum and an aluminum-tin alloy.

FIGS. 2 and 3 illustrate the microstructural structure of the bond between the bonding layer 3 and the bearing metal layer 4. With a view to keeping the diagram simple, the microstructure of the supporting layer 2 is not illustrated. The grain structures of the two layers and the soft phase 5 are schematically illustrated.

The microstructural structure of the bearing metal layer 4 is characterized by a pronounced boundary layer 6 between the bonding layer 3 and bearing metal layer 4. The boundary layer 6 is therefore formed by mutually adjoining surfaces 7, 8 of grains 9, 10 of the aluminum of the bonding layer 3 and the aluminum of the bearing metal layer 4 (FIG. 3). The contact of a bonding layer metal grain with a bearing metal grain does not constitute a separate grain boundary because a grain boundary exclusively separates regions having the same crystal structure but a different orientation. The contact between the two materials should instead be regarded as a synthetically produced interface.

Synthetically produced interfaces are usually not in energetic equilibrium because neither the lattice structure nor the orientation match one another and this leads to the formation of inhomogeneities in the adjoining crystallites and/or grains.

Relative to the overall bond between the bonding layer 3 and bearing metal layer 4, this synthetically generated boundary layer 6 represents a weak point because it is much less favorable than a grain boundary from an energy point of view (e.g. boundary surface energy). What this means from the macroscopic point of view is that the bonding and/or bonding strength of bonds with these boundary surfaces is unfavorable.

It is in this respect that the invention is intended to improve the bond strength.

The multilayer plain bearing based on the invention is produced by forming a flat primary material 11, parts of which are illustrated in FIGS. 4 to 6 for example.

The primary material 11 comprises the bonding layer 3 and the bearing metal layer 4 joined to the bonding layer 3 and/or consists of these layers. This primary material 11 is joined to the supporting layer 3 via the bonding layer 3.

The bonding layer 3 is made from aluminum or a first aluminum-based alloy. The bearing metal layer 4 is made from a second aluminum-based alloy. A fusion-metallurgy connection is formed between the bonding layer 3 and the bearing metal layer 4.

Furthermore, a bonding zone and/or bonding region 12 is formed between the bonding layer 3 and bearing metal layer 4 with a continuous grain boundary gradient between the two layers.

The expression continuous grain boundary gradient in the context of the invention should be understood as meaning that no boundary layer 6 (FIGS. 2 and 3) that is discernible by light microscopy is formed between at least the grains 9, 10 of aluminum of the bearing metal layer 4 and the bonding layer 3, as will be explained below with reference to FIGS. 4 to 6. This being the case, there is no interruption (discontinuity) in the grain boundaries between the bonding layer 3 and bearing metal layer 4.

To enable a better comparison to be made with the prior art, FIGS. 4 to 6 illustrate the structure (macroscopic and microscopic) of the primary material 11.

The macroscopic structure corresponds to the structure of a steel-aluminum plain bearing as explained in connection with FIGS. 1 to 3. FIGS. 1 and 4 therefore illustrate the same structure.

Accordingly, viewed macroscopically, the primary material 11 comprises the bonding layer 3 made from pure aluminum and the bearing metal layer 4 made from an aluminum-based alloy. Tin is heterogeneously incorporated in the aluminum-based alloy as a soft phase 5. Reference may be made to the explanations given in connection with FIG. 1 for details of this.

FIGS. 5 and 6 illustrate the microstructural structure of the primary material 11. As with FIG. 2, the microstructure of the supporting layer 2 is not illustrated in FIG. 5.

The difference compared with the prior art plain bearing is already evident from FIG. 5 but may be seen in particular from FIG. 6.

FIG. 6 provides a detailed illustration of the transition between the bonding layer 3 and the bearing metal layer 4. The primary material 11 does not have a pronounced boundary layer between the bonding layer 3 and bearing metal layer 4 as is the case with the plain bearing 1 based on the prior art illustrated in FIGS. 2 and 3. Instead, a continuous grain boundary gradient is formed within the composite comprising the bonding layer 3 and bearing metal layer 4 constituting the antifriction layer in this embodiment. The grain boundaries are therefore not interrupted by a synthetic interface in the sense described above. Nevertheless, from a macroscopic point of view, the primary material 11 respectively the antifriction layer has a bond of two different materials, namely pure aluminum and the aluminum-tin alloy, as schematically illustrated in FIG. 4.

In this primary material 11 and hence the multilayer plain bearing made from it, bonding between the bonding layer metal and the bearing metal is therefore assured exclusively by the cohesion of grain boundaries 13 between the individual crystallites or grains 9, 10 of the two materials. From an energy point of view, this is a favorable form of bonding. From a macroscopic point of view, this results in a higher mechanical bonding strength of the two bonding partners so that a multilayer plain bearing element (FIG. 7) made from them is capable of withstanding higher loads than a comparable plain bearing 1 based on the prior art. By comparable plain bearings is meant the macroscopic structure and the same combination of materials, e.g. steel-Al99.9-AlSn20 (supporting layer 1—bonding layer 3—bearing metal layer 4).

The presence of the continuous grain boundary gradient on the product can be demonstrated by a simple method (grain boundary etching) even though there is no difference in the macroscopic structure between a prior art plain bearing and a plain bearing based on the invention.

The reason for the improved bond strength primarily resides in the boundary energy.

In principle, a boundary (boundary layer 6 in FIGS. 2 and 3) is an interface at which two “bodies” lie one against the other with virtually no space between them but with a substantially poorer “fit” than is the case with a homogeneous “body” as viewed macroscopically. From an energy point of view, a boundary is therefore an unfavorable state because the outer bonds lying at the boundary point into “empty” space and/or in the direction of the oppositely lying other boundary that is not a fit in crystallographic terms. The “excess” bonding energy therefore has to be accommodated in the system, which leads to an unfavorable energy state. This situation is referred to as interfacial energy (J/m2).

A technical surface, e.g. such as used in roll bonding, has adsorption layers, oxide layers and species-specific peripheral layers even after thorough cleaning and activation (by means of degreasing, brushing or polishing processes). During roll bonding, these surfaces are bonded by means of high pressure. This destroys the adsorption layers, tears open the oxide reaction layers and results in contact with the species-specific peripheral layers. These then form the so-called boundary layer due to “mechanical anchoring”. Strictly speaking, there is no direct contact of the base materials. The mechanical anchoring is a mutual anchoring of the metals. An intimate contact is created, approaching atomic spacing. The bond by means of adhesion can be produced by high pressure, e.g. by a forming process (roll bonding).

Due to heat treatment at sufficiently high temperatures, the bonded partners (produced by mechanical anchoring) are rearranged in the bonding plane, the two materials being “mixed” on an atomic plane. However, there is no sliding transition of the lattice structure of the two bonding partners at this boundary layer and instead a dividing line is formed.

This boundary layer can be rendered visible in a metallographic micro-section by means of an appropriate etching process (e.g. using etching solution 5 m 0.5 ml HF acid in 100 ml H2O, for an etching time of 5 s to 60 s). The boundary layer is etched due to the fact that the inner species-specific peripheral layers contain locally altered chemical compositions and inhomogeneity in the adjoining lattice and are thus attacked by the etching solution, unlike the base material. The same principle applies to the etching of grain boundaries.

The bonding of the layers of the primary material 11 based on the invention offers a number of advantages compared with the mechanically anchored boundary layer, some of which were explained above.

The bond is assured by the cohesion of grain boundaries.

As explained above, a grain boundary by definition separates areas (crystallites or grains) in the crystal having a different orientation but the same crystal or lattice structure.

In the case of the mechanically anchored boundary, the lattice interface, the lattice no longer fits together correctly (even in the case of the same lattice type, e.g. cubic). In the case of this join, very complex structures are always created with so-called misfit dislocations, which are unfavorable in terms of energy.

For the sake of completeness, FIG. 7 illustrates a multilayer plain bearing element 14 made from a composite material in the form of a plain bearing half-shell. A three-layered embodiment is illustrated, consisting of the supporting layer 2, the bonding layer 3 joined to it and the bearing metal layer 4 joined to the latter. However, the multilayer plain bearing element 14 might also be a third-shell or quarter-shell, etc. The multilayer plain bearing shell may be combined with other (identical or different) bearing shells in a bearing mount to obtain a plain bearing.

However, other embodiments of the multilayer plain bearing element 14 are also possible, for example in the form of a bearing bush or thrust ring.

The supporting layer 2 is usually made from a hard material. Materials which might be used for the supporting layer 2, also referred to as a supporting shell, include bronzes, brass, etc. Based on the preferred embodiment, the supporting layer 2 is made from a steel.

The bearing metal layer 4 in the embodiment illustrated in FIG. 7 sits in direct contact with the component to be mounted during operation, for example a shaft.

It is also possible for the multilayer plain bearing 14 to have more than three layers, in which case at least one other layer can be provided on top of the bearing metal layer 4 and joined to it, for example an antifriction layer 15, as indicated by broken lines in FIG. 7. At least one intermediate layer may be provided between the bearing metal layer 4 and the antifriction layer 15, for example a diffusion barrier layer and/or another bonding layer. These layers may be layers deposited galvanically or by means of PVD or CVD processes. Similarly, a polymer-based layer may be applied, in particular an antifriction lacquer. Combinations of these are also possible.

FIG. 8 illustrates a cross-section of one embodiment of a layered composite used for the primary material 11 comprising and/or consisting of the supporting layer 2, the bonding layer 3 disposed on it and joined to it and the bearing metal layer 4 disposed on and joined to the latter. The bearing metal layer 4 may extend across the entire surface of the bonding layer 3. However, it is also possible for the bearing metal layer 4 to extend across only a partial area of this surface of the bonding layer 3.

The bonding layer 3 and the bearing metal layer 4 contain aluminum as the main constituent, which forms the matrix of the layers in each case.

For example, the bonding layer 3 may consist of pure aluminum (Al99 or Al99.9). The first aluminum-based alloy of the bonding layer 3 and/or the second aluminum-based alloy of the bearing metal layer 4 may contain at least one element selected from a group comprising or consisting of Si, Sb, Cu, Mn, Mg, Zn, Co, Zr, Ni, Sc, Er, Ti, V, Nb, Ta. The proportion of the at least one alloy element may be between 0.5% by weight and 15% by weight and/or the total proportion of these alloy elements in the aluminum-based alloy may be between 0.5% by weight and 25% by weight. Si and Sb act as hard phase elements and/or hard phase formers, the elements Cu, Mn, Mg, Zn serve as the main reinforcing elements and the elements Co, Zr, Ni, Sc, Er, Ti, V, Nb, Ta serve as additional reinforcing elements. Accordingly, at least one element from each of the three aforementioned groups of elements may be contained in the bonding layer 3 and/or bearing metal layer 4.

In the case where an overlay is provided on the bearing metal layer 4, it may be produced from the materials used for the bonding layer 3. This being the case, the primary material may therefore comprise two or three different aluminum materials.

Unlike the bonding layer 3, the aluminum-based alloy of the bearing metal layer 4 contains at least one soft phase element, selected from a group comprising Sn, Bi, In, Pb as well as mixtures thereof. The proportion of soft phase element and/or the total proportion may be at most 49.9% by weight, in particular between 3% by weight and 40% by weight. In particular, the soft phase element is non-miscible with the matrix element and forms a heterogeneous structural component of the alloy. The soft phase element is preferably Sn and/or Bi.

The bonding layer 3 is free of soft phases.

In principle, the first and the second aluminum-based alloys may differ, both in terms of quality and quantity. However, a preferred embodiment of the primary material 11 and hence the multilayer plain bearing element 14 is one in which the first aluminum-based alloy of the bonding layer 3 with the exception of the at least one soft phase element has the same qualitative composition as the second aluminum-based alloy of the bearing alloy layer 4. This being the case, it is possible for the aluminum-based alloys to differ solely due to the at least one soft phase element, i.e. the proportions of the other alloy elements in the two aluminum-based alloys are the same. For example, the first aluminum-based alloy of the bonding layer 3 may be AlCuMn and the second aluminum-based alloy of the bearing metal layer 4 may be AlSn20CuMn. Due to the qualitative and optionally quantitative similarity of the first and second aluminum alloys, they exhibit very similar solidification behavior, which significantly improves their suitability for cold rolling.

Based on another embodiment of the multilayer plain bearing element 14, in addition to aluminum, at least one alloy element of the first aluminum-based alloy of the bonding layer 3 and/or the second aluminum-based alloy of the bearing metal layer 4 has a concentration gradient in the bonding zone formed between the bonding layer 3 and the bearing metal layer 4 so that there is no abrupt transition in the concentration of the at least one alloy element in the bond formed by the bonding layer 3 and bearing metal layer 4. If several alloy elements are used, a concentration gradient is provided for at least one of and/or several of these alloy elements or all of the alloy elements. For example, the concentration gradient may be provided for only the at least one soft phase element.

In the context of the invention, the expression bonding zone may also be construed as being synonymous with the bonding region 12, having a layer thickness at the macroscopically perceptible interface between the bonding layer 3 and bearing metal layer 4 of at most 200 μm, in particular between 10 μm and 100 μm.

The layer thickness of the bonding layer 3 in the multilayer plain bearing element 14 may be between 100 μm and 1000 μm. In the as-cast state, having produced the composite casting and before processing it, the layer thickness of the bonding layer 3 may be between 2 mm and 12 mm.

The layer thickness of the bearing metal layer 4 may be between 100 μm and 3000 μm. In the as-cast state, the layer thickness of the bearing metal layer 4 may be between 8 mm and 20 mm.

Furthermore, the grain size of the grains 10 of the bonding layer 3 and/or the grains 9 of the bearing metal layer 4 in the bonding region 12 formed between the bonding layer 3 and bearing metal layer 4 may have an average maximum diameter of at most 100 μm. This is achieved by adding grain refining agents during the fusion metallurgy process in combination with appropriate thermo-mechanical process controls in a manner known from the prior art.

By average diameter is meant the average linear grain size, also known as the Heyn grain size. This structural characteristic is measured on the basis of micrographs visually evaluated in accordance with the guidelines governing quantitative structural analysis, in a manner known from the prior art.

In this respect, it is of advantage if a proportion of at least 25% of the grains 9, 10 relative to the totality of the grains 9, 10 in the bonding region 12, at least formed in the bonding region 12 between the bonding layer 3 and bearing metal layer 4, have an approximately globular habit.

The primary material 11 is produced by a composite casting so that the bonding layer 3 is joined to the bearing metal layer 4 by fusion metallurgy. To this end, the molten material for the bearing metal layer 4 may be cast onto the solid bonding layer 3. Conversely, however, another option would be to cast the molten material for the bonding layer 3 onto the solid bearing metal layer 4.

Alternatively, it is also possible for the bonding layer 3 or the bearing metal layer 4 to be melted at least in the region of its surface and the material for the bearing metal layer 4 or bonding layer 3 is cast onto the at least partially molten material of the bonding layer 3 or bearing metal layer 4.

FIG. 9 illustrates the preferred embodiment of a device 16 for producing the composite casting from the bonding layer 3 and bearing metal layer 4. Since the sequence of the casting process may vary as explained above, the description below will refer solely to a substrate 17 and a cast-on layer 18. The substrate 17 may be the bonding layer 3 or the bearing metal layer 4 and accordingly the cast-on layer 18 may be the bearing metal layer 4 or the bonding layer 3. The first and second aluminum-based alloys will be selected depending on which of these is the case.

The process of producing the multilayer plain bearing element 14 generally comprises the following method steps: comprising the steps:
producing the two-layer primary material 11 from a first aluminum-based alloy forming a first layer of the primary material 11 and a second aluminum-based alloy forming a second layer of primary material 11 by composite casting;
joining the two-layer primary material 11 to a substrate which forms the supporting layer 2 of the multilayer plain bearing element 14 by roll bonding;
finishing the roll-bonded composite material to obtain the multilayer plain bearing element 14.

The device 16 for producing the composite casting has at least one first zone 19, a second zone 20 directly adjoining it and a third zone 21 directly adjoining it. In the first zone 19, a first strand 22 of aluminum or of one of the aluminum-based alloys is produced from a first aluminum (alloy) melt 23. In the second zone 20, the first strand 22 of first aluminum (alloy) melt 23 is cooled at least to the degree that it has a solidified first surface 24. In the third zone 21, a second strand 25 of aluminum or of the other aluminum-based alloy from a second aluminum (alloy) melt 26 is cast onto the solidified first surface 24, with the proviso that if using aluminum, the other strand 22 or 25 respectively is produced from the aluminum-based alloy.

The device 16 has a first, bottom endless belt 27 and a second, top belt 28, respectively guided by a number of rollers. The first, bottom belt 27 extends across the entire length of the device 16 in the production direction. The second, top belt 28, on the other hand, extends across only a partial region of this entire length, as may be seen in FIG. 9. This partial region defines the first zone 19 of the device.

A vertical distance 29 defines the casting cavity for the substrate 17, i.e. the substrate layer thickness, which may be between 2 mm, in particular 6 mm, and 20 mm, depending on the substrate material used. The width of the casting cavity (in the direction looking down from above onto FIG. 9) may be up to 450 mm, for example.

The first aluminum (alloy) melt 23 is applied to the first bottom belt 27 by means of a casting nozzle 30 disposed horizontally at the start of the device 16. To this end, this casting nozzle 30 extends between the first bottom belt 27 and the second top belt 28.

Disposed underneath the first, bottom belt 27 is a first cooling unit 31 having at least one first cooling passage 32 through which a coolant is circulated, and the first, bottom belt 27 preferably lies directly adjoining this first cooling unit 31. The first cooling unit 31 may comprise a cooling plate 33, e.g. made of copper, in which the at least one first cooling passage 32 is disposed.

Furthermore, disposed above the second, top belt 28 is a second cooling unit 34 having at least one second cooling passage 35 through which a coolant is circulated, and the second, top belt 28 preferably lies adjoining this second cooling unit 34. The second cooling unit 34 may comprise a cooling plate 36, e.g. made from copper, in which the at least one second cooling passage 35 is disposed.

The first cooling unit 31 extends more or less across the entire length of the device 16 in the production direction. The second cooling unit 34, on the other hand, extends only at least approximately across the entire length of the first zone 20. As a result, the first strand 22 in zone 20 adjoining the first zone 19 is not forcibly cooled. This enables the thermal conditions at the first, top surface 24 of the substrate 17 to be improved in readiness for casting the second strand 25.

The cooling plates 33, 36 are disposed at least approximately parallel with one another.

The melting heat is drawn out of the melt of the first strand 25 by means of the first and second cooling units 31, 34. Based on a preferred embodiment of the method, cooling in the region of the first surface 24 of the first strand 22 takes place at a cooling rate selected from a range of 1° C./s to 15° C./s. In this respect, the cooling rate is preferably adapted to the belt speed (s). To this end, based on another embodiment of the method, in the first zone 19 the first strand 22 is preferably cooled in the region of the first surface 24 to a temperature that is not less than 400° C., in particular between 400° C. and 550° C.

At least the first, bottom belt 27 is driven such that the cast melt is conveyed in the production direction (from left to right in FIG. 9). However, the second, top belt 28 may also be driven, in which case the two belt speeds are synchronized with one another, for example by means of a servomotor.

The casting speed can be set and/or varied on the basis of the belt speed (s).

Disposed at the end of the device 16 is a casting unit 37 by means of which the aluminum (alloy) melt for the second strand 25 is cast onto the surface 24 of the first strand 22.

The horizontal distance between the start of this casting unit 37 and the end of the second, top belt 28 (as viewed in the production direction respectively) defines the length of the second zone 20 of the device 16. Accordingly, the third zone of the device 16 is defined by the length of the start of the casting unit 37 and the end of the first, bottom belt 27.

The casting unit 37 is designed so that it can be displaced in the production direction, thereby enabling the lengths of the second and third zones 20, 21 to be varied. This therefore enables the bond strength between the cast-on layer 18 and the substrate 17 to be influenced, especially if primary materials 11 are being produced from different alloy compositions, because the thermal conditions at the first surface 24 of the first strand 22 can be influenced.

The casting unit 37 preferably has a vertically disposed casting nozzle 38. It is also preferable if the casting nozzle 38 can be moved in the casting direction. The thickness of the casting outlet of the casting nozzle 38 may be 4 mm to 12 mm for example. The cast-on thickness is preferably the same as the casting gap thickness of the casting nozzle 38. The casting gap of the casting nozzle 38 may be straight or of a conically converging design. The casting width of the casting nozzle is preferably the same as the width of the casting cavity for the substrate 17.

The cast-on layer 18 is cast onto the substrate 17 by means of the casting unit 37. The substrate 17 is preferably already completely solid, i.e. has solidified, at least in the region of the surface 24, upstream of the casting unit 37.

Based on another preferred embodiment of the method, the first strand 22 is cooled in a cooling line having top cooling circuits assigned to the first surface 24 of the first strand 22 and bottom cooling circuits assigned to a second surface 39 of the first strand 22, and the number of top cooling circuits is smaller than the number of bottom cooling circuits. To this end, the at least one cooling passage 32 of the bottom cooling unit 31 may be divided into several, in particular three, cooling circuits that are independent of one another. The top cooling unit 34 may be formed by only a single cooling passage 35.

It should be pointed out that the cooling plates 33, 36 may have a number of partial passages which are disposed one after the other in the production direction and in particular extend transversely to the production direction, as illustrated in FIG. 9. However, these partial passages may comprise a single cooling passage in that these partial passages extend in a meandering layout, for example. On the longitudinal sides of the device 16, two collecting passages may also be provided and the partial passages run out from one of the collecting passages and open into the other one. These designs should be construed as being part of the concept of “one cooling passage” because they are not independent of one another but are fluidically connected to one another.

If several independent cooling passages are provided, there is no such fluidic connection between the individual cooling passages.

An arrangement other than the aforementioned 3:1 split of independent cooling passages is also possible, for example only two bottom ones and one top one or two top ones and four bottom ones, etc.

The fact that the bottom cooling unit 31 has a greater number of mutually independent cooling passages means that cooling of the first strand 22 can be more accurately influenced, thereby enabling the thermal conditions of the first strand to be more accurately controlled and hence the adhesive strength of the second, top strand 25 on the first, bottom strand to be improved.

Similarly with a view to better controlling the thermal conditions of the first strand at the first surface 24, the first strand 22 is cooled in the region of a left-hand and a right-hand side 40 based on another preferred embodiment. This is preferably achieved by bringing the lateral sides 40 of the first strand 22 into contact with a material having a lower thermal conductivity than copper. It is particularly preferable to cool the lateral sides 40 by bringing them into contact with graphite strips which may be positioned at the sides downstream of the casting nozzle 30. The graphite strips can be passively cooled or, based on another embodiment of the device 1, may also be cooled indirectly, for which purpose they may be mounted in direct contact with water-cooled copper strips or the latter are mounted on the graphite strips. The copper strips may therefore also serve as strips for the graphite strips. This assures a more homogeneous temperature profile in the first strand in the region of the first surface 24 22 so that the bonding quality between the first strand 22 and second strand 25 can be improved across the entire width of the first strand 22 (i.e. as viewed perpendicular to the plane of the page in the plan view of FIG. 9). This results in higher quality in terms of the solidification front of the first, bottom strand 22 at least in the region of the first surface 24, which is at least approximately linear, in particular linear. What this achieves in particular is that more homogeneous thermal conditions prevail across the casting width when casting the second strand 25.

In order to cool the sides of the first strand 22 if using indirect water cooling of the graphite strips, it is of advantage in the case of another embodiment to use a relatively small volumetric flow of water of between 0.5 l/minute and 1 l/minute so that the water is at a temperature close to evaporation point.

Alternatively, it is also possible for the lateral sides 40 of the first strand 22 to be tempered downstream of the casting nozzle 30, for example again by means of directly or indirectly heated graphite strips. The tempering process may be operated using an oil as the transfer medium, for example.

Based on another embodiment of the method, having been cast onto the first surface 24 of the first strand 22, the second strand 25 is cooled by another cooling unit 41 having another cooling circuit 42, and the solidification front of the second strand 25 is formed upstream of this other cooling circuit 42. The other cooling circuit 42 is therefore disposed downstream of and spaced apart from the casting nozzle 38 of the casting unit 37 in the production direction. This being the case, the material for producing the cast-on layer 18 remains in the molten liquid state for as long as possible, thereby enabling formation of the continuous grain boundary gradient between the substrate 17 and cast-on layer 18 to be improved, in other words the bonding layer 3 and the bearing metal layer 4 in the finished multilayer plain bearing element 14.

For the reasons outlined above, it is also of advantage if, based on another embodiment of the method, cooling of the two strands 22, 25 is operated such that the first aluminum-based alloy is produced with a substantially globular structure and the second aluminum-based alloy is produced with a substantially dendritic structure. The grain size may be between 5 μm and 100 μm.

The other cooling unit 41 preferably has a graphite plate 43 which is indirectly cooled, for example by a copper cooler through which a coolant such as water is circulated, for example. The graphite plate 43 reduces adherence of the other cooling unit 41 on the second strand 25, thereby obviating the need for additional lubrication. Furthermore, graphite has a relatively low thermal conductivity (compared with copper), which further promotes formation of the continuous grain boundary gradient.

The surface topography of the first, bottom belt 27 and the second, top belt 28 in contact with the first strand 22 imparts a corresponding surface topography to the first strand 22, which can have a positive effect on the bond with the supporting layer 2 and/or top strand 25.

A primary material 11 can be produced as follows, for example.

substrate 17 AlSn25Cu1Mn having a 12 mm thickness
cast-on layer 18 Al99.5 having a 12 mm thickness
hence D=1
melting temperature of the aluminum alloy melt 23: 780-820° C.
casting temperature 660-700° C.
casting rate 0.5-0.6 m/min
melting temperature of the aluminum melt 26: 820-850° C.
cast-on casting temperature 750-800° C.
substrate belt temperature during casting on 500-550° C.
cooling power/circulation through side strips by first strand 22: 5-10 l/min

When the cast-on layer 18 is cast onto the substrate 17, the latter is superficially melted again. The melted zone may extend to a depth in the substrate 17, measured from the surface 14, of between 1 mm and 5 mm.

The primary material 11 produced in this manner had an adhesive strength of the layers in the as-cast state, measured by means of an adapted tensile test (a cuboid sample having a thickness of 3 mm and laterally screwed clamping jaws were used) of at least 60 N/mm², i.e. the adhesive strength is therefore higher than the tensile strength of the weaker component Al99.7, which has a tensile strength of ca. 45 N/mm² under the same measuring conditions.

Similar results were also obtained with other material combinations (see tables below).

In terms of bond strength, i.e. the bond created between the bonding layer 3 and bearing metal layer 4, it has proved to be of advantage if the aluminum-based alloys used to produce the first and second strand 22, 25 have melting points which differ by at most 15% relative to the melting point of the aluminum-based alloy having the higher melting point or, if using aluminum to produce the first or second strand 22, 25, the aluminum-based alloy used to produce the other strand has a melting point that is higher than the melting point of aluminum by at most 15%. Examples of this are the combination of an Al99 bonding layer 3 having a melting point of ca. 660° C. and AlSn40Cu1Mn bearing metal layer 4 having a melting point of ca. 615° C. or the combination of an AlZn5MgCu bonding layer having a melting point of ca. 650° C. and AlSn20Cu bearing metal layer having a melting point of ca. 630° C.

To produce the fusion-metallurgy bonding of the bonding layer 3 to the bearing metal layer 4, it has proved to be of advantage in terms of casting and hence the bond strength of the bond between bonding layer 3/bearing metal layer 4 if a layer thickness ratio D between 2:1 and 1:10, in particular between 3:2 and 2:3 is used for casting purposes, the layer thickness ratio D being the ratio of the layer thickness of the substrate to the layer thickness of the respective cast-on layer. For example, the layer thickness (in the as-cast state) of the bearing metal layer 4, being the substrate, is 8 mm and the layer thickness of the bonding layer 3, being the caston layer, is 4 mm.

The cast composite material produced by any of these different methods may then be subjected to a process to reduce the thickness to that required of the supporting layer 2-roll-bonded material by cold rolling depending on the material and thickness, optionally with at least one intermediate annealing in order to improve deformability and optionally for adjusting a concentration profile of at least one alloy element between the bearing metal layer 4 and bonding layer 3. The strips obtained in this manner can then be cut to the required length and width, oriented, cleaned, degreased and the surface on the side of the bonding layer 3 activated by means of a grinding process.

Bonding of the primary material 11 by means of the bonding layer 3 and supporting layer 2 is preferably effected by roll bonding.

This may then be followed by further heat treatment in order to obtain an appropriate structure in the bearing metal layer 4 and/or to improve the bond between the different layers and/or to adjust a concentration gradient for at least one alloy constituent between the bearing metal layer 4 and bonding layer 3.

For the respective cast-on layer, in other words the bearing Metal layer 4 or the bonding layer 3, another option is to make the layer by casting material melt more than once, in which case the bearing metal layer 4 or bonding layer 3 is made up of at least two partial layers.

In order to evaluate the invention, the following tests were conducted.

Using the device 16, composites were produced where the material for the bonding layer 3 was cast onto the solid bearing metal layer 4 (substrate) (tests number 1 to 10) and composites where the material for the bearing metal layer 4 was cast onto the solid bonding layer 3 (substrate) (tests number 11 and 12). Table 1 below sets out a selection of the composites produced.

TABLE 1
Test variants

| Test number | Substrate alloy | Casting alloy | Ratio D |
|---|---|---|---|
| 1 | AlSn6Cu1Ni1 | Al99.5 | 1 |
| 2 | AlSn6Cu1Ni1 | AlZn4Si1.5 | 1.2 |
| 3 | AlSn20Cu1 | Al99.5 | 1 |
| 4 | AlSn20Cu1 | AlZn4Si1.5 | 1.2 |
| 5 | AlSn25Cu1Mn | Al99.5 | 1 |
| 6 | AlSn25Cu1Mn | AlZn4Si1.5 | 1.2 |
| 7 | AlSn40Cu1 | Al99.5 | 1 |
| 8 | AlZn5Bi5MnZr | Al99.5 | 1 |
| 9 | AlZn5Bi5MnZr | AlZn4Si1.5 | 1.2 |
| 10 | AlZn5Bi5MnZr | AlZn5CuMg | 1.5 |
| 11 | Al99.5 | AlSn6Cu1Ni1 | 0.1 |
| 12 | AlZn4Si1.5 | AlSn25Cu1Mn | 0.25 |
| 13 | AlCu1Mn | AlSn25Cu1Mn | 1 |
| 14 | AlCu1Mn | AlSn20Cu1 | 1 |
| 15 | AlCu1Mn | AlSn6Cu1Ni | 1 |
| 16 | AlSn25Cu1Mn | AlCu1Mn | 1 |
| 17 | AlSn20Cu1 | AlCu1Mn | 1 |
| 18 | AlSn6Cu1Ni | AlCu1Mn | 1 |

At this stage, it should be reiterated that the ratio D describes the thickness ratio on the composite after the casting process. By running optional processing steps, the ratio can be adjusted as desired depending on the required layer thickness in the finished plain bearing and depending on the intended application. Table 2 below sets out corresponding embodiments.

TABLE 2
Examples of possible embodiments

| | | Bonding | Bearing | Layer | |
|---|---|---|---|---|---|
| | Main | layer | alloy | thicknesses | |
| No. | body | A1 | A2 | A1 (mm) | A2 (mm) |
| 1 | steel | Al99.5 | AlSn6Cu1Ni1 | 0.2 | 0.6 |
| 2 | steel | Al99.5 | AlSn20Cu1 | 0.2 | 0.6 |
| 3 | steel | Al99.5 | AlSn25Cu1Mn | 0.2 | 0..6 |
| 4 | steel | Al99.5 | AlZn5Bi5MnZr | 0.2 | 0.6 |
| 5 | steel | AlZn4Si1.5 | AlSn6Cu1Ni1 | 0.2 | 0.6 |
| 6 | steel | AlZn4Si1.5 | AlSn25Cu1Mn | 0.2 | 0.6 |
| 7 | steel | AlZn4Si1.5 | AlZn5Bi5MnZr | 0.2 | 0.6 |
| 8 | steel | Al99.0 | AlSn6Cu1Ni1 | 0.2 | 0.6 |
| 9 | steel | Al99.0 | AlZn5Bi5MnZr | 0.2 | 0.6 |
| 10 | steel | AlZn5CuMg | AlSn25Cu1Mn | 0.1 | 0.7 |
| 11 | steel | AlZn5CuMg | AlSn25Cu1Mn | 0.2 | 0.6 |
| 12 | steel | AlZn5CuMg | AlSn25Cu1Mn | 0.4 | 0.4 |
| 13 | steel | AlZn5CuMg | AlZn5Bi5MnZr | 0.1 | 0.7 |
| 14 | steel | AlZn5CuMg | AlZn5Bi5MnZr | 0.2 | 0.6 |
| 15 | steel | AlZn5CuMg | AlZn5Bi5MnZr | 0.4 | 0.4 |
| 16 | steel | Al99.5 | AlSn40Cu1 | 0.2 | 0.6 |
| 17 | steel | Al99.0 | AlSn40Cu1 | 0.2 | 0.6 |
| 18 | steel | AlZn4Si1.5 | AlSn40Cu1 | 0.2 | 0.6 |
| 19 | steel | Al99.0 | AlSn6Cu1Ni1 | 0.1 | 0.4 |
| 20 | steel | AlZn4Si1.5 | AlSn25Cu1Mn | 0.1 | 0.4 |
| 21 | steel | AlZn4Si1.5 | AlSn25Cu1Mn | 0.4 | 0.1 |
| 22 | steel | Al99.5 | AlZn5Bi5MnZr | 0.1 | 0.4 |
| 23 | steel | AlZn5CuMg | AlZn5Bi5MnZr | 0.1 | 0.4 |
| 24 | steel | AlZn5CuMg | AlZn5Bi5MnZr | 0.4 | 0.1 |
| 25 | steel | Al99.5 | AlSn40Cu1 | 0.5 | 1.0 |
| 26 | steel | Al99.5 | AlSn40Cu1 | 0.5 | 1.5 |
| 27 | CuSn5Zn | Al99.0 | AlSn6Cu1Ni1 | 0.2 | 0.6 |
| 28 | CuSn5Zn | AlZn4Si15 | AlSn6Cu1Ni1 | 0.2 | 0.6 |

It would go beyond the scope of this description to list the test results for all the test variants in full. The description below is therefore limited to a few different variants.

For the tests described below, test pieces were produced for the torsion test, alternating bending test and scuffing load test. To provide a comparison, roll-bonded composites having the same structures and same composition as those of the specified examples were tested.

In the case of the torsion test, the sample is subjected to a torsional load, torsion corresponding to twisting the sample alternately to the right and to the left by 90° respectively. After every twist, the sample is inspected for detachments. The twist number of a sample corresponds to the number of twists to the point at which detachments of a defined shape and extension first occur.

In the case of the alternating bending test, the sample is subjected to a (path-controlled) bending load having an R value of −1 (pure alternating load) at a specific frequency. Cracks were detected using adhered resistance measuring strips.

In the case of the scuffing load test, the bearing shell is subjected to a load that is increased in steps in a bearing testing machine at a constant shaft circumferential speed of 12.6 m/s, a constant oil flow of 1.1 l/min and a constant oil temperature of 120° C. In this test, a series of at least three plain bearings of the same type are subjected respectively to the specified load under comparable conditions until scuffing occurs and/or until the maximum load step is reached. The average scuffing load calculated from the maximum load measured in MPa at the onset of scuffing and/or maximum load step in MPa for all plain bearings of the respective series is then recorded in a block diagram.

FIG. 10 sets out the results of the torsion test as a test for the qualitative adhesive strength. This test is used to determine comparative values for the strength of the bond (adhesive strength) between the individual layers. The test and the comparative values for adhesive strength on which it is based apply solely to the comparison of state, shape and dimensions of totally identical samples. The test is conducted by twisting a sample anchored by one end so that it cannot move respectively by 90° to the right and to the left alternately. A deflection by 90° to the right and left and the subsequent rebound to the middle position are together referred to as a twist. During the test, the sample is subjected to a pre-set number of twists and the set twists are applied one after the other. If tearing and/or any detachment occur during the test, the test is terminated and the number of twists applied up to that point is recorded in the test protocol.

In FIG. 10, the number of twists of each sample is plotted on the abscissa in the form of a measurement point in the row in the normal probability plot in which the sample is recorded. The absolute number of twists is plotted on the ordinate. At least three tests were conducted for each test variant (at least three measurement points in the normal probability plot for each variant). In order to sort the respective measurement values more effectively, the ideal line (separating line) is also plotted in the normal probability plot.

What should also be pointed out in respect of these tests is that only the adhesion between the bonding layer 3 and bearing metal layer 4 was tested in these tests. It would also have been possible to test adhesive strength between the steel—supporting layer 2 and bonding layer 3 but this was not the case in the variants evaluated in Table 1.

The qualitative adhesive strength determined by the torsion test was found to be above an acceptance line 44 (describing the minimum number of twists to be obtained) and above the region 45 of roll-bonded composites. Curves 46 to 50 represent the composites based on the invention (see Table 1, tests number 1, 2, 6, 7 and 10).

FIG. 11 and FIG. 12 set out the results of the alternating bending test conducted as a test for the fatigue strength of the multilayer plain bearing element 14 in accordance with DIN 50142 at room temperature. In this instance, stress in MPa is plotted on the ordinate and the number of load changes to the point at which cracking is first detected (damage line 51, 52) and the time of sample failure (failure line/fatigue line 53, 54) in a logarithmic scale on the abscissa.

It should be pointed out at this stage that all figures relating to standards in this description are based on the version of the respective standard valid on the date of this application.

In respect of this testing, it should be noted that the tests were conducted only on composites consisting of a bonding layer 3 and bearing metal layer 4 with a finished layer thickness ratio of 1:1 in order to determine differences in terms of quality of the adhesion between the composites based on the invention and composites based on the prior art.

As may be seen from FIG. 11 and FIG. 12, the fatigue strengths of the composites based on the invention, denoted by damage lines 52, lie in principle at the same level as the fatigue strengths of the composites based on the prior art, denoted by damage lines 51. However, this result is not surprising because the composites are respectively made from the same alloy combinations. However, a major advantage of the composites based on the invention compared with the composites based on the prior art is demonstrated by the position of the failure lines/fatigue lines (curves 53 and 54). The region between damage line 52 and failure line/fatigue line 54, i.e. the region of overstraining incurring material damage, is greater in the case of the composites based on the invention than the composites based on the prior art, delimited by damage line 51 and failure line/fatigue line 53. What this means in terms of the functionality of the component made from a composite based on the invention is that a total failure of the bearing shell and/or antifriction layer (e.g. detachment of the antifriction layer) occurs later than is the case with bearing shells produced from composites based on the prior art. In other words, the composites based on the invention withstand a higher degree of prior damage before the point of total failure.

FIG. 13 illustrates the results of the scuffing load test in the form of a block diagram. With an average maximum scuffing load of 100 MPa, the composite based on the invention has a significantly higher value (block 55) than the composite based on the prior art (block 56), which has an average maximum scuffing load of 68 MPa.

For comparison purposes, roll-bonded composites of identical structures and identical composition to those specified in the examples were produced. These comparative examples were then subjected to a heat treatment (long time annealing for 3 hours at 350° C. and for 120 hours at 400° C.). During this, the interfaces between the bonding layer and bearing metal layer did not change. In other words, a roll-bonded join cannot be turned into a join such as that produced by composite casting.

The bearing metal layer 4 and/or the bonding layer 3 may be produced with grains 9, 10 having a minimum average grain size of 20 μm. In particular, the bearing metal layer 4 and/or the bonding layer 3 may also be produced with a layer thickness of more than 100 μm.

The multilayer plain bearing 14 may be used in all sizes and types of engine, for example engines of heavy goods vehicles or large two-stroke marine engines or automotive vehicle engines.

The embodiments illustrated as examples represent possible variants of the multilayer plain bearing element 14 and the method of producing it, and it should be pointed out at this stage that different combinations of the individual embodiments with one another are also possible.

For the sake of good order, finally, it should be pointed out that, in order to provide a clearer understanding of the structure of the multilayer plain bearing element 14, it and its constituent parts are illustrated to a certain extent out of scale and/or on an enlarged scale and/or on a reduced scale.

List of reference numbers

| | |
|---|---|
| 1 | Plain bearing |
| 2 | Supporting layer |
| 3 | Binding layer |
| 4 | Bearing metal layer |
| 5 | Soft phase |
| 6 | Boundary layer |
| 7 | Surface |
| 8 | Surface |
| 9 | Grain |
| 10 | Grain |
| 11 | Primary material |
| 12 | bonding region |
| 13 | Grain boundary |
| 14 | Multilayer plain bearing element |
| 15 | Antifriction layer |
| 16 | Device |
| 17 | Substrate |
| 18 | cast-on layer |
| 19 | Zone |
| 20 | Zone |
| 21 | Zone |
| 22 | Strand |
| 23 | Aluminum (alloy) melt |
| 24 | Surface |
| 25 | Strand |
| 26 | Aluminum (alloy) melt |
| 27 | Belt |
| 28 | Belt |
| 29 | Distance |
| 30 | Casting nozzle |
| 31 | Cooling unit |
| 32 | Cooling passage |
| 33 | Cooling plate |
| 34 | Cooling unit |
| 35 | Cooling passage |
| 36 | Cooling plate |
| 37 | Casting unit |
| 38 | Casting nozzle |
| 39 | Surface |
| 40 | Side |
| 41 | Cooling unit |
| 42 | Cooling circuit |
| 43 | Graphite plate |
| 44 | Acceptance line |
| 45 | Region |
| 46 | Curve |
| 47 | Curve |
| 48 | Curve |
| 49 | Curve |
| 50 | Curve |
| 51 | Damage line |
| 52 | Damage line |
| 53 | Fatigue line |
| 54 | Fatigue line |
| 55 | Block |
| 56 | Block |

1. Multilayer plain bearing element (14) made from a composite material comprising a supporting layer (2), a bonding layer (3) joined to the supporting layer (2) and a bearing metal layer (4) joined to the bonding layer (3), the bonding layer (3) being made from aluminum or a first, soft-phase-free aluminum-based alloy and the bearing metal layer (4) being made from a second aluminum-based alloy containing at least one soft phase, and the bonding layer (3) and the bearing metal layer (4) are joined to one another by means of a fusion-metallurgy join forming a bonding zone between the bonding layer (3) and the bearing metal layer (4), grains (9,10) being formed in the bonding zone, wherein a continuous grain boundary gradient is formed in the bonding zone between the bonding layer (3) and the bearing metal layer (4).

2. Multilayer plain bearing element (14) according to claim 1, wherein the first aluminum-based alloy of the bonding layer (3) and/or the second aluminum-based alloy of the bearing metal layer (4) contains or contain at least one (other) alloy element and the alloy element has a concentration gradient in the bonding zone formed between the bonding layer (3) and bearing metal layer (4).

3. Multilayer plain bearing element (14) according to claim 1, wherein the grain size of the grains (9, 10) in the bonding zone formed between the bonding layer (3) and bearing metal layer (4) has an average maximum diameter of at most 100 μm.

4. Multilayer plain bearing element (14) according to claim 1, wherein a proportion of at least 25% of the grains (9, 10) relative to the totality of grains (9, 10) in the bonding zone have an approximately globular habit, at least in the bonding zone formed between the bonding layer (3) and bearing metal layer (4).

5. Multilayer plain bearing element (14) according to claim 1, wherein the first aluminum-based alloy of the bonding layer (3) with the exception of the at least one soft phase element has the same qualitative composition as the second aluminum-based alloy of the bearing metal layer (4).

6. Method for producing a multilayer plain bearing element (14) comprising the steps:
producing a two-layer primary material (11) from a first aluminum-based alloy forming a first layer of the primary material (11) and a second aluminum-based alloy forming a second layer of the primary material (11) by composite casting;
joining the two-layer primary material (11) to a substrate forming a supporting layer (2) of the multilayer plain bearing element (14) by roll bonding;
finishing the roll-bonded composite material to obtain the multilayer plain bearing element (14),
wherein
the composite casting process for producing the primary material (11) is operated in a device (16) having at least three different zones and, in a first zone (19) a first strand (22) of aluminum is produced from an aluminum melt or of one of the aluminum-based alloys from a first aluminum alloy melt (23), in a second zone (20) the first strand (22) of aluminum melt or the first aluminum-based alloy melt (23) is cooled until it has a solidified first surface (24) and in a third zone (21) a second strand (25) of aluminum from an aluminum melt or the other aluminum-based alloy from a second aluminum alloy melt (26) is cast onto the solidified first surface (24), with the proviso that if using aluminum, the other strand (22 or 25) is produced respectively from the second aluminum-based alloy.

7. Method according to claim 6, wherein the first strand (22) is cooled in a cooling line having top cooling circuits assigned to the first surface (24) of the first strand (22) and bottom cooling circuits assigned to a second surface (39) of the first strand (22), and the number of the top cooling circuit or top cooling circuits is smaller than the number of bottom cooling circuits.

8. Method according to claim 6, wherein the first strand (22) is cooled in the region of the first surface (24) at a cooling rate selected from a range of 1° C./s to 15° C./s.

9. Method according to claim 6, wherein the first strand (22) is cooled in the region of the first surface (24) to a temperature that is not less than 400° C.

10. Method according to claim 6, wherein the first strand (22) is cooled in the region of lateral sides (40).

11. Method according to claim 6, wherein having been cast onto the first surface (24) of the first strand (22), the second strand (25) is cooled by another cooling circuit, the solidification front of the second strand (25) being formed upstream of this other cooling circuit.

12. Method according to claim 6, wherein the first aluminum-based alloy is produced with a substantially globular structure and the second aluminum-based alloy is produced with a substantially dendritic structure.

13. Method according to claim 6, wherein the aluminum-based alloys used to produce the first and second strand (22, 25) have melting points which differ by at most 15% relative to the melting point of the aluminum-based alloy having the higher melting point or, if using aluminum to produce the first or second strand (22 or 25), the aluminum-based alloy used for the other strand (25 or 22) has a melting point which is at most 15% higher than the melting point of aluminum.

14. Method according to claim 6, wherein the primary material (11) is produced with a layer thickness ratio D of between 2:1 and 1:10, the layer thickness ratio being the ratio of the layer thickness of the first strand (22) to the layer thickness of the second strand (25) after the casting process.
